(19) United States
(12) Patent Application Publication
(10) Pub. No.: US 2014/0003325 A1
(43) Pub. Date: Jan. 2, 2014

(54) RELAY COMMUNICATION SYSTEM AND RELAY COMMUNICATION DEVICE

(71) Applicant: MURATA MACHINERY, LTD., Kyoto-shi (JP)

(72) Inventor: Yoshifumi TANIMOTO, Kyoto (JP)

(21) Appl. No.: 13/909,307

(22) Filed: Jun. 4, 2013

(30) Foreign Application Priority Data
Jun. 27, 2012 (JP) 2012-144741
Jun. 27, 2012 (JP) 2012-144743
Feb. 15, 2013 (JP) 2013-28369

(51) Int. Cl. H04W 16/26

(52) U.S. Cl. CPC H04W 16/26
USPC 370/315

(57) ABSTRACT

A relay communication device includes a first communication unit, a second communication unit, and a communication buffer. When receiving data in the first communication unit, each relay communication device temporarily accumulates the data in the communication buffer. The relay communication device functioning as a master asks the relay communication device functioning as a slave if there is data in the communication buffer. The master grants transmission permission to the slave that has returned a reply indicating that there is data. The slave that has received the transmission permission transmits the data to a slave that is a destination of the data. The master makes an inquiry into a next slave in the case where the slave which has been granted the transmission permission completes the transmission of the data from the second communication unit. The allowed amount of data transmitted by each relay communication device at one time is limited.

### CROSS-REFERENCE TO RELATED APPLICATIONS

This application claims priorities under 35 U.S.C. 119 to Japanese Patent Application Nos. 2012-144741 and 2012-144743 filed on Jun. 27, 2012, and 2013-28369 filed on Feb. 15, 2013, which applications are hereby incorporated by reference in their entirety.

### BACKGROUND OF THE INVENTION

1. Field of the Invention

The present invention relates to a configuration for avoiding transmission collision in a relay communication system that allows relay communication devices to communicate with each other.

2. Description of the Related Art

There has been known an adapter that transforms serial communication such as RS-232C or CAN (Controller Area Network) into wireless communication. Transforming communication between devices that had been connected to each other by wire into wireless provides such technical advantages as being cableless.

Apparatuses performing such wireless communication cannot perform normal communication when transmission collision, in which a plurality of apparatuses simultaneously performs transmission, occurs. Therefore, various configurations have been suggested to avoid transmission collision.

In a field of wireless LAN, for example, Japanese Patent Publication No. 4018449 describes a communication method employing central arbitration control. In the central arbitration control, an access point having central arbitration function assigns communication right to each wireless communication device by controlling the communication right and sequentially polling each wireless communication device. A configuration in which the polling is performed in this manner is described in Japanese Patent Publication No. 3971404, for example.

In such a case where a wireless communication device to which transmission right is granted by the polling transmits a large amount of data, data transmission takes time so that other wireless communication devices are forced to wait for a long time period before transmitting data. Thus, a system in which responsiveness is critical (for example, a system required to reliably perform a communication within a specific predetermined time) cannot employ the above-described configuration.

There has also been known a configuration in which each wireless communication device performs transmission at its own timing without polling and is forced to wait for transmission for a randomly-determined time period when transmission collision occurs. Since apparatuses are forced to wait for a random time period, the apparatuses can obtain timing for transmission that is not overlapped with timing of other apparatuses, avoiding transmission collision. However, this configuration cannot ensure responsiveness since forcing the apparatuses to wait for transmission causes delay. In particular, since waiting time is randomly determined, communication delay cannot be projected in advance. In addition, the delay may be longer (i.e., the waiting time may be longer).

In this respect, Japanese Unexamined Patent Publication No. 2001-86137 discloses a configuration in which different signal transmission timings are allocated to slave station devices by prioritizing slave station devices having a high data transmission frequency. Japanese Unexamined Patent Publication No. 2001-86137 thus ensures that collision of signals wirelessly transmitted to a master station device can be prevented from occurring between slave station devices having a high data transmission frequency so that throughput decrease of an entire system can be prevented with improved communication efficiency.

However, since the number of request signal slots is limited in the configuration of Japanese Unexamined Patent Publication No. 2001-86137, a larger number of the slave devices requires a larger ratio of slave devices to which the request signal slots cannot be fixedly allocated. As a result, increase of transmission collision of request signals cannot be avoided. Therefore, the configuration of Japanese Unexamined Patent Publication No. 2001-86137 can ensure responsiveness of a system only in a case where the number of the slave devices is small.

As described above, regardless of using polling or not, the conventional art cannot ensure responsiveness of the system.

### SUMMARY OF THE INVENTION

Preferred embodiments of the present invention provide a relay communication system arranged to reliably prevent transmission collision and to ensure responsiveness. According to one preferred embodiment of the present invention, a relay communication system includes a plurality of relay communication devices and a communication control device. Each of the relay communication devices includes a first communication unit, a second communication unit, a communication buffer, a transmission data processing unit, and a received data processing unit. The first communication unit communicates with a terminal device connected thereto. The second communication unit communicates with at least the communication control device. The communication buffer temporarily accumulates data received via the first communication unit. The transmission data processing unit starts transmitting the data accumulated in the communication buffer from the second communication unit in accordance with transmission permission from the communication control device and limits the amount of the data allowed to be transmitted with one transmission permission to a predetermined amount of the data or less. The received data processing unit transmits, in the case where a destination of the data received via the second communication unit is the terminal device connected thereto, the data from the first communication unit. The communication control device includes a communication unit, a polling processing unit, a transmission permission granting unit, and a polling restart processing unit. The communication unit communicates with one of the plurality of relay communication devices. The polling processing unit transmits to the one of the plurality of relay communication devices an inquiry signal that inquires whether or not data has accumulated in the communication buffer in accordance with a predetermined order. The transmission permission granting unit interrupts the inquiry by the polling processing unit in a case of receiving a reply indicating that data has accumulated in the one of the plurality of relay communication devices to which the inquiry signal has been transmitted, and transmits the transmission permission to one of the plurality of relay communication devices that has returned the reply. The polling restart processing unit causes the polling processing unit to restart the inquiry into a next relay communication device after transmission of the data is completed.

According to the above-described preferred embodiment, since the data is transmitted from the relay communication device only in the case where the communication control device grants permission, transmission collision can be prevented before the collision happens. Accordingly, since communication delay caused by transmission collision can be avoided, responsiveness of the entire relay communication system can be ensured. Additionally, since the inquiry from the communication control device to each of the relay communication devices is performed in the predetermined order (not in a random order), the transmission permission is reliably granted to the relay communication device having data to be transmitted within a predetermined time period. Since the amount of data to be transmitted at one time from the relay communication device can be limited to the predetermined amount of data or less, the inquiry by the communication control device can be prevented from being interrupted for a long period of time. The responsiveness of the relay communication system can thus be improved.

In the above-described relay communication system, it is preferred that the relay communication device accumulates the data in the communication buffer only in the case where the destination of the data received via the first communication unit is a terminal device connected to other relay communication device.

That is, in the case where an apparatus, which is the destination of the data, is connected to the first communication unit, the data is not required to be accumulated in the communication buffer. Therefore, by not accumulating such data in the communication buffer, the volume of the communication buffer can be saved.

In the above-described relay communication system, frequency of transmission of the inquiry signal by the polling processing unit may vary by relay communication device.

Accordingly, such flexible preferential handling grants an opportunity for data transmission to a specific relay communication device to be available.

The above-described relay communication device is preferably configured as follows. That is, each of the relay communication devices preferably includes a destination acquiring unit arranged to specify the relay communication device that is a destination of the data accumulated in the communication buffer. The second communication unit of each of the relay communication devices can communicate with other relay communication device. The transmission data processing unit of each of the relay communication devices transmits the data to the relay communication device specified by the destination acquiring unit in accordance with the transmission permission.

In this configuration, each relay communication device transmits the data to another relay communication device only in the case where the communication permission is granted. Transmission collision thus can be reliably prevented.

The above-described relay communication device also may be configured as follows. That is, the transmission data processing unit of each of the relay communication devices is configured to transmit the data to the communication control device in accordance with the transmission permission. The communication control device includes a destination acquiring unit arranged to specify the relay communication device that is a destination of data to be transmitted from the communication unit, and a data transfer processing unit arranged to cause the destination acquiring unit to specify the relay communication device to which the data, received from the relay communication device to which the transmission permission has been granted, is to be transferred, and to transmit the data to the specified relay communication device.

In this configuration, since the communication control device transfers the data transmitted by each relay communication device in an integrated manner, transmission collision can be reliably prevented. According to another preferred embodiment of the present invention, a relay communication device with the following configuration is provided. That is, a relay communication device includes an operation mode setting unit, a first communication unit, a second communication unit, a communication buffer, a transmission data processing unit, a received data processing unit, a polling processing unit, a transmission permission granting unit, and a polling restart processing unit. The operation mode setting unit sets whether to function as a communication control device or a slave device. The first communication unit communicates with a terminal device connected thereto. The second communication unit communicates with another relay communication device. The communication buffer temporarily accumulates data received via the first communication unit. The transmission data processing unit starts, in the case of functioning as the slave device, transmitting the data accumulated in the communication buffer from the second communication unit in accordance with transmission permission from a relay communication device functioning as the communication control device and limits the amount of the data allowed to be transmitted with one transmission permission to a predetermined amount of the data or less. The received data processing unit transmits, in the case where a destination of the data received via the second communication unit is the terminal device connected thereto, the data from the first communication unit. The polling processing unit transmits to the relay communication device functioning as the slave device an inquiry signal that inquires whether or not data has accumulated in the communication buffer in a predetermined order in a case of functioning as the communication control device. The transmission permission granting unit interrupts the inquiry by the polling processing unit and transmits the transmission permission to one of the plurality of relay communication devices that has returned the reply in the case of functioning as the communication control device and receives from the relay communication device the reply indicating that data has accumulated in the one of the plurality of relay communication devices to which the inquiry signal has been transmitted. The polling restart processing unit causes the polling processing unit to restart the inquiry into the next relay communication device after transmission of the data is completed in the case of functioning as the communication control device.

Since the relay communication device is configured to be capable of functioning also as the communication control device, cost can be reduced by commonly providing the hardware, enabling a flexible configuration of the relay communication system.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a view illustrating an overall configuration of a relay communication system according to a first preferred embodiment of the present invention.

FIG. 2 is a block diagram illustrating a relay communication device according to the first preferred embodiment of the present invention.

FIG. 3 is a view exemplifying contents of a device information table according to a preferred embodiment of the present invention.

FIG. 4 is a flowchart illustrating operations of a slave according to the first preferred embodiment of the present invention.

FIG. 5 is a flowchart illustrating operations of a master according to the first preferred embodiment of the present invention.

FIG. 6 is a sequence diagram illustrating the relay communication system according to the first preferred embodiment of the present invention.

FIG. 7 is a view illustrating an overall configuration of a relay communication system according to a second preferred embodiment of the present invention.

FIG. 8 is a block diagram illustrating a relay communication device according to the second preferred embodiment of the present invention.

FIG. 9 is a flowchart illustrating operations of a slave according to the second preferred embodiment of the present invention.

FIG. 10 is a flowchart illustrating operations of a master according to the second preferred embodiment of the present invention.

FIG. 11 a sequence diagram illustrating the relay communication system according to the second preferred embodiment of the present invention.

FIG. 12 is a view illustrating an overall configuration of a relay communication system according to a variant preferred embodiment of the present invention.

### DETAILED DESCRIPTION OF THE PREFERRED EMBODIMENTS

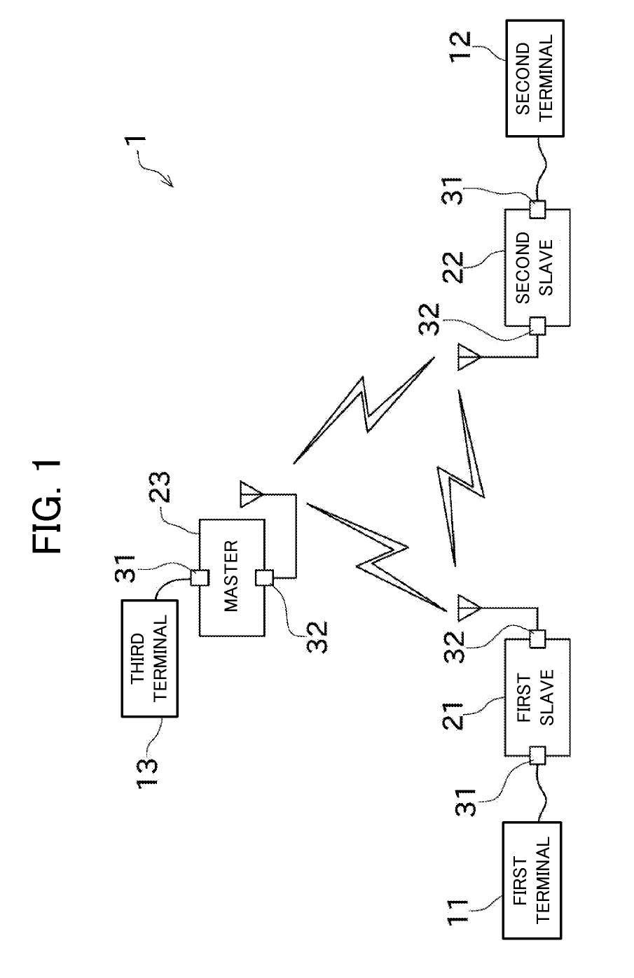

Next, preferred embodiments of the present invention will be described with reference to the drawings. An overall configuration of a relay communication system 1 according to a first preferred embodiment of the present invention is illustrated in FIG. 1.

The relay communication system preferably includes a plurality of terminal devices 11, 12, and 13. The terminal devices 11, 12, and 13 are apparatuses designed on a condition that the terminal devices 11, 12, and 13 preferably communicate with each other by wired serial communication such as, for example, RS-232C or CAN. Although three terminal devices (a first terminal 11, a second terminal 12, and a third terminal 13) are preferably included in a non-limiting example of FIG. 1, which is a minimum configuration, the relay communication system 1 may include four or more terminal devices, for example.

Each terminal device 11, 12, and 13 is wire-connected to a relay communication device. The relay communication device is provided correspondingly for each terminal device. In the example of FIG. 1, for example, the first terminal 11, the second terminal 12, and the third terminal 13 are preferably respectively connected to a first relay communication device 21, a second relay communication device 22, and a third relay communication device 23.

The relay communication devices are configured to be capable of wirelessly communicating with each other. The relay communication devices 21, 22, and 23 are devices arranged to transform communication, between the terminal devices 11, 12, and 13 designed on a condition that the terminal devices 11, 12, and 13 communicate with each other by wire communication, into wireless. That is, the relay communication device is wire-connected to each terminal device such that the relay communication device relays communication between the terminal devices. Accordingly, the wired serial communication can be converted into wireless communication. Although three relay communication devices 21, 22, and 23 are preferably included in the non-limiting example of FIG. 1, in the case where four or more terminal devices are provided, four or more relay communication devices may be included correspondingly.

One of a plurality of the relay communication devices included in the relay communication system 1 also functions as a communication control device. In the case of FIG. 1, for example, the third relay communication device 23 preferably functions as the communication control device. The third relay communication device 23 as the communication control device, functions to control transmission timing of wireless communication of each relay communication device. In this manner, since the communication between the relay communication devices is adjusted by the communication control device in an integrated manner, transmission collision can be prevented from occurring.

The third relay communication device 23 functioning as the communication control device, and other relay communication devices (the first relay communication device 21 and the second relay communication device 22) preferably have an identical hardware configuration. Each relay communication device 21, 22, and 23 can be set by software with respect to whether or not each relay communication device 21, 22, and 23 functions as the communication control device. Therefore, any relay communication device of the plurality of the relay communication devices 21, 22, and 23 included in the relay communication system 1 may function as the communication control device. However, only one relay communication device can function as the communication control device in one relay communication system 1. In this manner, since the configuration of hardware is in common between the communication control device and other relay communication devices, cost can be reduced. Since the relay communication device functioning as the communication control device can be changed if required, the relay communication system 1 can be configured more flexibly.

In a description below, a relay communication device functioning as the communication control device may be referred to as a “master”, and the other relay communication devices may be referred to as a “slave”. In the case of FIG. 1, for example, the third relay communication device 23, the first relay communication device 21, and the second relay communication device 22 are respectively referred to as the “master”, a “first slave”, and a “second slave”.

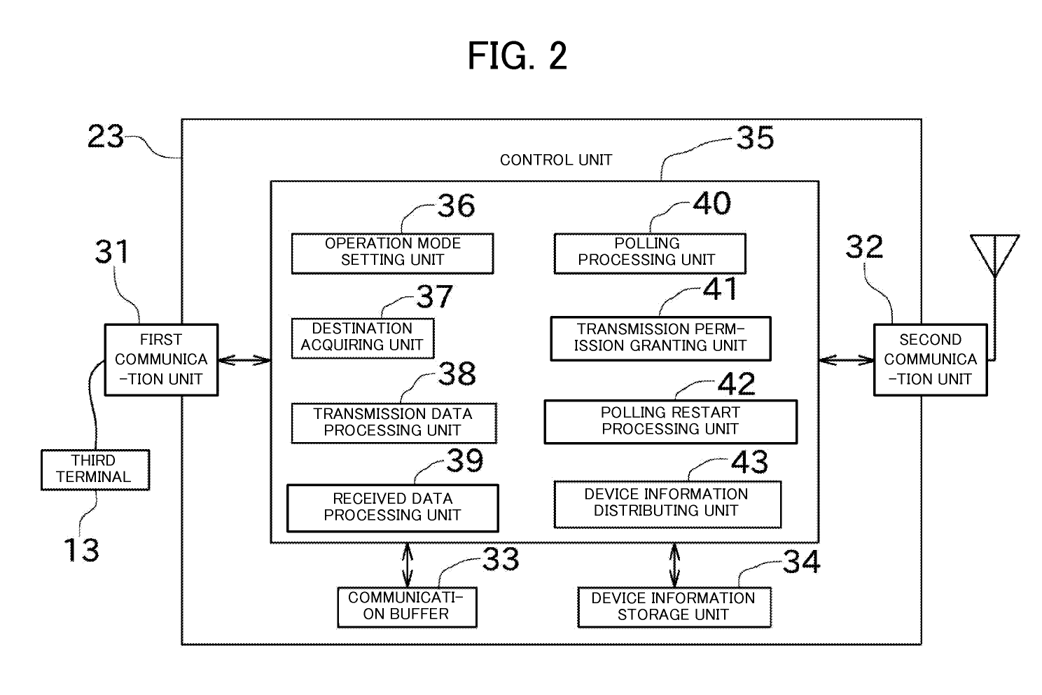

Next, a configuration of the relay communication device will be described in detail with reference to FIG. 2. As described above, the relay communication devices 21, 22, and 23 preferably have common hardware, the third relay communication device 23 is illustrated as a representative in FIG. 2.

The relay communication device preferably includes a first communication unit 31, a second communication unit 32, a communication buffer 33, a device information storage unit 34, and a control unit 35.

The first communication unit 31 is configured to be capable of communicating with a terminal device connected thereto. A communication method of the first communication unit 31 is not particularly limited. In the present preferred embodiment, since each terminal device is preferably premised on performing wired serial communication such as, for example, RS-232C or CAN, the first communication unit 31 is configured to be connected to the terminal device connected thereto by the wired serial communication.

In the configuration, data transmitted by the terminal device is received by the first communication unit 31 of the relay communication device to which the terminal device is connected. Data transmitted from the first communication unit 31 by the relay communication device is received by the terminal device connected to the relay communication device. A unique identifier (e.g., a terminal ID) in the relay communication system 1 is assigned to each terminal device 11, 12, and 13. Each terminal device attaches, information that designates the terminal ID of a destination terminal device, to data when transmitting the data.

The second communication unit 32 is preferably utilized in communication with other relay communication device. A communication method by the second communication unit 32 is not particularly limited. For example, in the present preferred embodiment, the second communication unit 32 of each relay communication device is preferably configured to perform communication by a wireless LAN (preferably IEEE 802.11, for example).

A unique identifier (an IP address, for example) in the relay communication system 1 is assigned to each relay communication device 21, 22, and 23. When the relay communication devices communicate with each other via the second communication units 32, the communication is performed after having designated an identifier (an IP address) of the relay communication device which is a communication destination.

The communication buffer 33 is a memory region arranged to temporarily accumulate data received from the terminal device connected thereto via the first communication unit 31. The data accumulated in the communication buffer is transmitted from the second communication unit 32 when transmission permission is granted from the relay communication device (a master) that functions as the communication control device (described later). In the description below, the data accumulated in the communication buffer 33 is referred to as “transmission waiting data”, which means data waiting to be transmitted.

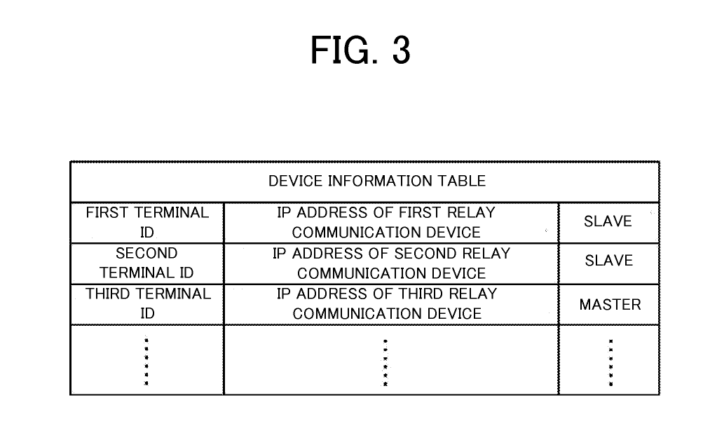

The device information storage unit 34 stores device information that associates the identifier (the IP address) of each relay communication device included in the relay communication system 1, with the identifier (the terminal ID) of the terminal device connected to the relay communication device. Since the plurality of relay communication devices exist in the relay communication system 1, there are some pieces of device information stored in the device information storage unit. Therefore, storage contents of the device information storage unit 34 can preferably be described in a table format as in FIG. 3, for example. In the description below, the storage contents of the device information storage unit 34 is referred to as “device information table”. The identifier of each relay communication device can be managed by a MAC address in addition to an IP address.

A device information table having the same contents is preferably stored in the device information storage unit 34 of each relay communication device that is included in the relay communication system 1. In the present preferred embodiment, for example, the device information table of which contents are illustrated in FIG. 3 is stored in each device information storage unit 34 of the three relay communication devices 21, 22, and 23 in FIG. 1. Information on which relay communication device functions as the communication control device is stored in the device information table. In an example of FIG. 3, for example, stored is information which indicates that the third relay communication device 23 is the master (the communication control device), and the first relay communication device 21 and the second relay communication device 22 are the slaves.

The control unit 35 preferably including hardware such as a CPU, a ROM, and a RAM, and software arranged to control the hardware, is configured and programmed to realize various functions by working the hardware and the software together. Specifically, the control unit 35 is preferably configured and programmed to be capable of functioning as an operation mode setting unit 36, a destination acquiring unit 37, a transmission data processing unit 38, a received data processing unit 39, a polling processing unit 40, a transmission permission granting unit 41, a polling restart processing unit 42, or the like.

The operation mode setting unit 36 of each relay communication device is configured to set an operation mode on whether the relay communication device functions as the master or the slave. The operation mode setting unit 36 is preferably set by an administrator of the relay communication system 1 when installing the relay communication device.

The destination acquiring unit 37 is configured to specify the relay communication device, which is a destination of transmission waiting data, with reference to the storage contents of the device information storage unit 34. In FIG. 1, for example, when the first terminal 11 transmits data bound for the second terminal 12 and then the data is accumulated in the communication buffer 33 of the first relay communication device 21, the destination acquiring unit 37 of the first relay communication device 21 acquires the terminal ID of the terminal device which is the destination of the data (the second terminal 12 in this example) by analyzing the transmission waiting data. Subsequently, by referring to the device information table, the destination acquiring unit 37 acquires the IP address of the relay communication device connected to the terminal device that is specified as the destination (the second relay communication device 22 in this example). In such a manner, the destination acquiring unit 37 can acquire the IP address of the relay communication device to which the transmission waiting data is to be transmitted (the second relay communication device 22 in the above-described example).

The transmission data processing unit 38 transmits the transmission waiting data from the second communication unit 32 to the IP address acquired by the destination acquiring unit 37 when receiving a transmission permission signal (described later) from the master. The data transmitted in this manner is received in the second communication unit 32 of the relay communication device, which is the destination. The transmission data processing unit 38 transmits a transmission completion report to the master via the second communication unit 32 when the transmission of the transmission waiting data is completed.

In the relay communication device of the present preferred embodiment, the transmission data processing unit 38 is configured to limit the amount of data allowed to be transmitted from the second communication unit 32 at one time to a predetermined amount of data or less. That is, in the case where the amount of transmission waiting data accumulated in the communication buffer 33 exceeds the predetermined amount of data (a predetermined number of bytes), the transmission data processing unit 38 of the relay communication device transmits only the predetermined amount of the data from the second communication unit 32, when the transmission permission is granted, and terminates the data transmission of this time. The rest of the data is transmitted in order from next time onward when the transmission permission is granted. If the amount of the transmission waiting data accumulated in the communication buffer 33 is at the predetermined amount of data or less, all of the data may be transmitted when the transmission permission is granted.

The received data processing unit 39 transmits, in a case where the data received in the second communication unit 32 is bound for the terminal device connected thereto, the data from the first communication unit 31. The data transmitted from the first communication unit 31 of the relay communication device in this manner is received by the terminal device connected to the relay communication device.

With the above-described configuration, data can be wirelessly transmitted from a terminal device connected to a relay communication device to a terminal device connected to another relay communication device via the relay communication devices.

Next, the polling processing unit 40, the transmission permission granting unit 41 and the polling restart processing unit 42 will be described. The functions are specific in the case where the operation mode of the relay communication device is that of the master (in the case of functioning as the communication control device).

The polling processing unit 40 transmits an inquiry signal that inquires whether or not there is transmission waiting data, from the second communication unit 32 to relay communication devices (slaves) other than itself (master). Transmission of the inquiry signal to each slave is performed in accordance with a predetermined order. The polling processing unit 40 makes an inquiry into a next slave in the case of receiving a reply of “no transmission waiting data” from a slave to which the inquiry has been performed.

Although an order in which the inquiry signals are transmitted to a plurality of slaves is not particularly limited, the inquiries are preferably required to be performed in a predetermined order. This is because if a slave to which the inquiry signal is transmitted is determined in a random manner, performing a reliable inquiry into each slave within a predetermined time period cannot be ensured.

The polling processing unit 40 of the present preferred embodiment is preferably configured to make the inquiry into the relay communication devices (slaves) other than itself in an order of the device information table stored in the device information storage unit 34. In FIG. 3, for example, since the IP address of the first relay communication device, the IP address of the second relay communication device . . . are stored in the device information table in this order, the inquiry into each slave is performed in such order stored in the table as the first relay communication device (the first slave) 21, the second relay communication device (the second slave) 22 . . . . In the case where the inquiry into a last slave stored in the device information table is completed, the inquiry may be continued by returning to the first slave in the device information table. By this configuration, the inquiries to all the slaves can be reliably performed within the predetermined time period.

When receiving a reply of “transmission waiting data exists” from a slave to which the inquiry signal has been transmitted, the transmission permission granting unit 41 transmits the transmission permission signal from the second communication unit 32 to the slave. The transmission permission granting unit 41 is configured to interrupt the inquiry by the polling processing unit 40 in the case of transmitting the transmission permission to the slave. Accordingly, the relay communication device other than the slave to which the transmission permission has been granted by the master does not perform transmission using the second communication unit 32. Therefore, the slave to which the transmission permission has been granted can transmit data from the second communication unit 32 without transmission collision with another relay communication device. According to the configuration of the present preferred embodiment, since transmission collision can be reliably prevented, delay caused by transmission collision is prevented from occurring, with improved responsiveness of the entire relay communication system 1.

The polling restart processing unit 42 causes the polling processing unit 40 to restart the inquiry in the case of receiving the transmission completion report in the second communication unit 32 from the slave to which the transmission permission has been granted.

As described above, the master sequentially makes the inquiry into each slave on whether or not transmission waiting data exists so that the transmission permission can be granted to a slave having transmission waiting data.

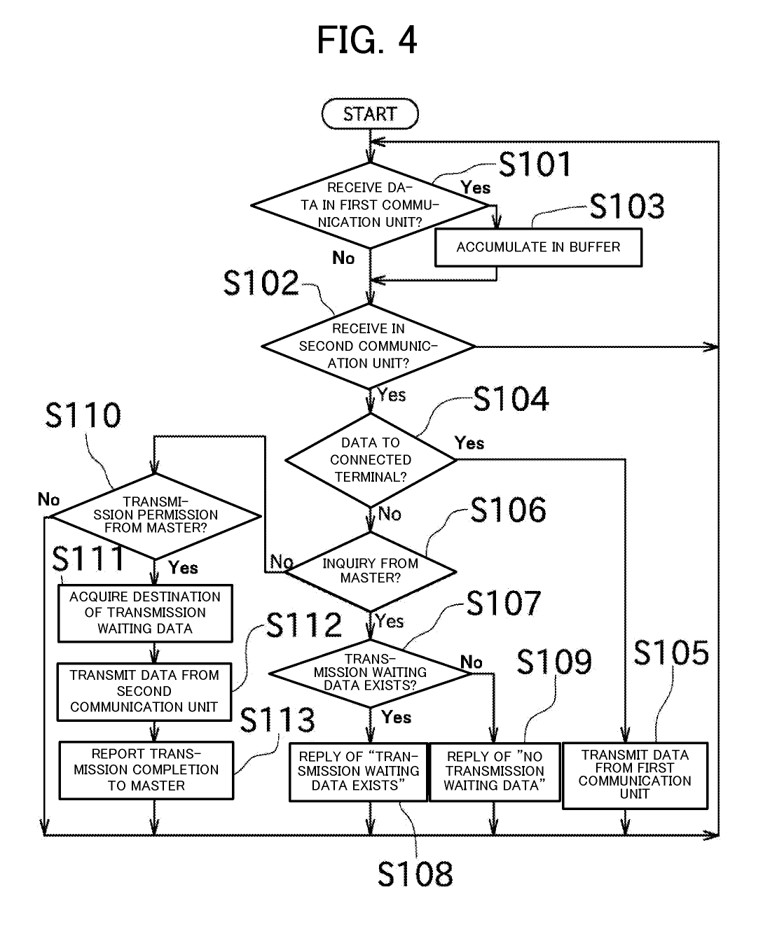

Next, operations of the relay communication device that functions as the slave will be described with reference to a flowchart of FIG. 4.

The relay communication device functioning as the slave monitors whether or not data is received in the first communication unit 31 and the second communication unit 32(step S101 and step S102). In the case where data is received in the first communication unit 31 (in the case of receiving the data from the terminal device connected thereto), the slave accumulates the received data in the communication buffer 33 (step S103).

In the case where data is received in the second communication unit 32 of the slave, processing is branched in accordance with a type of the received data. In the case where data received in the second communication unit 32 is the data bound for a terminal device connected thereto (step S104), the received data processing unit 39 transmits the data from the first communication unit 31 (step S105). Accordingly, the data is received by the terminal device connected to the first communication unit 31 of the slave.

On the other hand, in the case where the inquiry signal from the master is received in the second communication unit 32 (step S106), the slave replies to this. That is, in the case where the transmission waiting data exists (determination in step S107), the slave preferably replies “transmission waiting data exists” to the master using the second communication unit 32 (step S108). On the other hand, in the case where transmission waiting data does not exist, the slave preferably replies “no transmission waiting data” to the master using the second communication unit 32 (step S109).

In the case where the transmission permission signal from the master is received in the second communication unit 32 (step S110), the slave transmits the transmission waiting data. The destination acquiring unit 37 firstly acquires the IP address of the relay communication device to which the transmission waiting data is to be transmitted (step S111), and the transmission data processing unit 38 transmits the transmission waiting data to the acquired IP address (step S112). In the case where the transmission of the transmission waiting data is completed, the transmission data processing unit 38 reports accordingly to the master (step S113).

As described above, in the present preferred embodiment, the amount of data allowed to be transmitted from the second communication unit 32 at one time is preferably limited to the predetermined amount or less. That is, in the case where the predetermined amount of the data is transmitted from the second communication unit 32 in step S112, even if the transmission waiting data is remained, the data transmission of this time is completed to proceed to step S113. The remaining data is transmitted from next time onward.

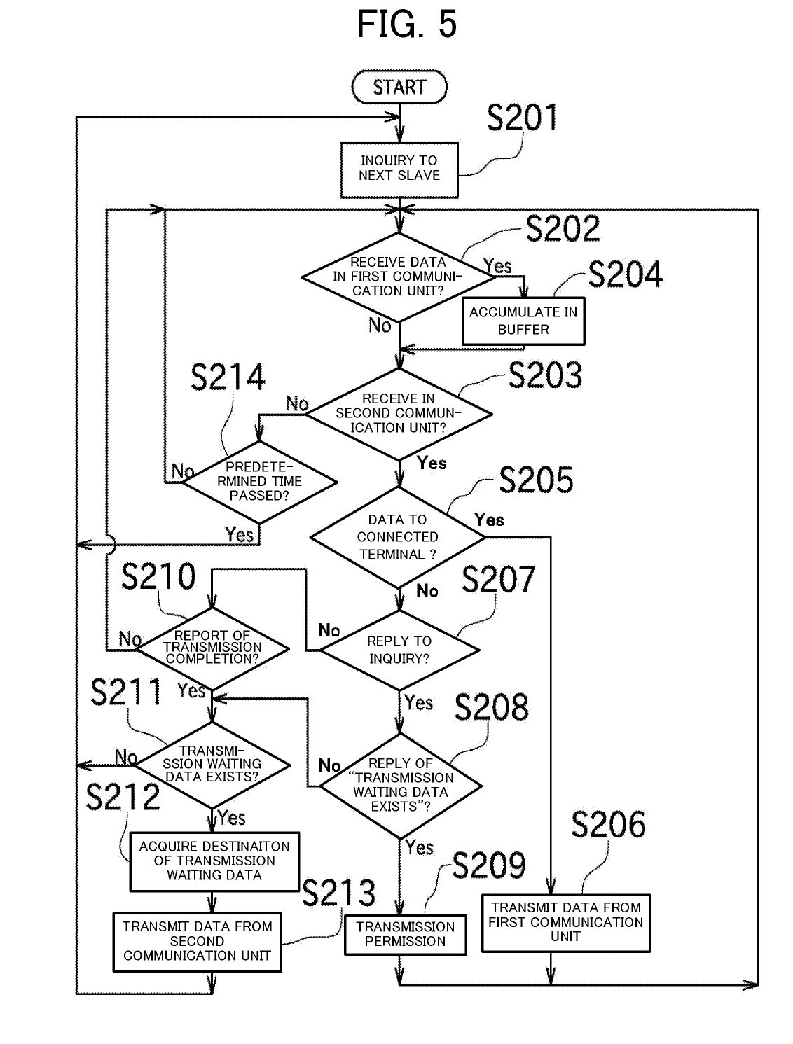

Next, operations of the relay communication device that functions as the master will be described with reference to a flowchart of FIG. 5.

Firstly, the polling processing unit 40 transmits the inquiry signal to the slave (step S201). As described above, the inquiry signal to a slave is transmitted in such order as stored in the device information table.

The relay communication device functioning as the master also monitors whether or not data is received in the first communication unit 31 and the second communication unit 32 in the same manner as the slave does (step S202 and step S203). In the case of receiving data in the first communication unit 31 (in the case of receiving data from the terminal device connected thereto), the master accumulates the received data in the communication buffer 33 (step S204).

In the case where data is received in the second communication unit 32 of the master, processing is branched in accordance with a type of the received data. In the case where the data received in the second communication unit 32 is the data bound for a terminal connected thereto (step S205), the received data processing unit 39 transmits the data from the first communication unit 31 (step S206). Accordingly, the data is received by the terminal device connected to the first communication unit 31 of the master.

Even the relay communication device functioning as the master preferably performs the same operations as the slave does in terms of relaying data transmitted to a terminal device connected thereto. Therefore, each terminal device can communicate regardless of whether a relay communication device to which the terminal device is connected is the master or the slave.

In the case where a reply from the slave in response to the inquiry signal is received in the second communication unit 32 of the master (step S207), the master branches processing in accordance with contents of the reply. That is, in the case of receiving a reply of “transmission waiting data exists” from the slave (determination in step S208), the transmission permission granting unit 41 of the master transmits the transmission permission signal from the second communication unit 32 to the slave (step S209). Accordingly, the data is transmitted from the second communication unit 32 of the slave to which the permission has been granted.

In this case, the transmission permission granting unit 41 that has transmitted the transmission permission signal to the slave interrupts the inquiry by the polling processing unit 40 (step S201). This is realized by returning to step S202 after step S209 in the flowchart of FIG. 5.

In the case where the transmission completion report from the slave to which the transmission permission has been granted is received in the second communication unit 32 (step S210), the polling restart processing unit 42 preferably causes the polling processing unit 40 to restart the inquiry processing (that is, returning to step S201). In the case where the reply from the slave in response to the inquiry signal is “no transmission waiting data” (the determination in step S208), without transmitting the transmission permission signal, the polling processing unit 40 continues the inquiry processing (that is, returning to step S201).

After the transmission permission is granted to the slave in step S209, until the slave completes the transmission of data, the inquiry by the master into another slave is interrupted. If the transmission of the data by the slave to which the transmission permission has been granted takes time, another slave is forced to wait, causing the responsiveness of the system to be lowered.

In this respect, in the present preferred embodiment as described above, the amount of data allowed to be transmitted from the second communication unit 32 of the slave at one time is limited to a predetermined data amount or less. In this manner, since the transmission of the data by the slave to which the transmission permission has been granted is reliably completed in the predetermined time period, the inquiry into another slave by the master can be prevented from being interrupted for a long period of time. Accordingly, the responsiveness of the relay communication system can be improved.

As described above, in the case where the terminal device connected to the master transmits data, the transmission waiting data is being accumulated in the communication buffer 33 of the master (step S204). The data is thus required to be transmitted from the second communication unit 32 at an appropriate timing.

In the present preferred embodiment, the relay communication device functioning as the master is configured to transmit its own transmission waiting data before making the inquiry into the next slave. That is, before making the inquiry into the next slave (before returning to step S201), the master determines whether or not there is its own transmission waiting data (step S211). In the case where the master does not have transmission waiting data, the master returns to step S201 and makes the inquiry into the next slave.

In the case where the master has transmission waiting data, the master interrupts the inquiry into the next slave and transmits its own transmission waiting data. That is, the destination acquiring unit 37 of the master acquires the IP address of the relay communication device to which the transmission waiting data is to be transmitted (step S212), and the transmission data processing unit 38 transmits the transmission waiting data to the acquired IP address (step S213). The master returns to step S201 and restarts the inquiry into the next slave in the case where the transmission of the data is completed by the transmission data processing unit 38.

In the present preferred embodiment, even in the case where the master transmits transmission waiting data, the amount of data allowed to be transmitted from the second communication unit 32 at one time is limited to a predetermined amount of data or less. In this manner, since the inquiry into the slave by the master can be prevented from being interrupted for a long period of time, the responsiveness of the relay communication system can be improved.

According to the above-described configuration, the master can transmit its own transmission waiting data from the second communication unit 32 in between the inquiries into the slaves.

There is a case where the reply from the slave cannot be received within the predetermined time period for some reason. The master is thus configured to make the inquiry into the next slave without waiting for the reply from the slave in the case where the reply from the slave is not received in the second communication unit 32 within a predetermined time period.

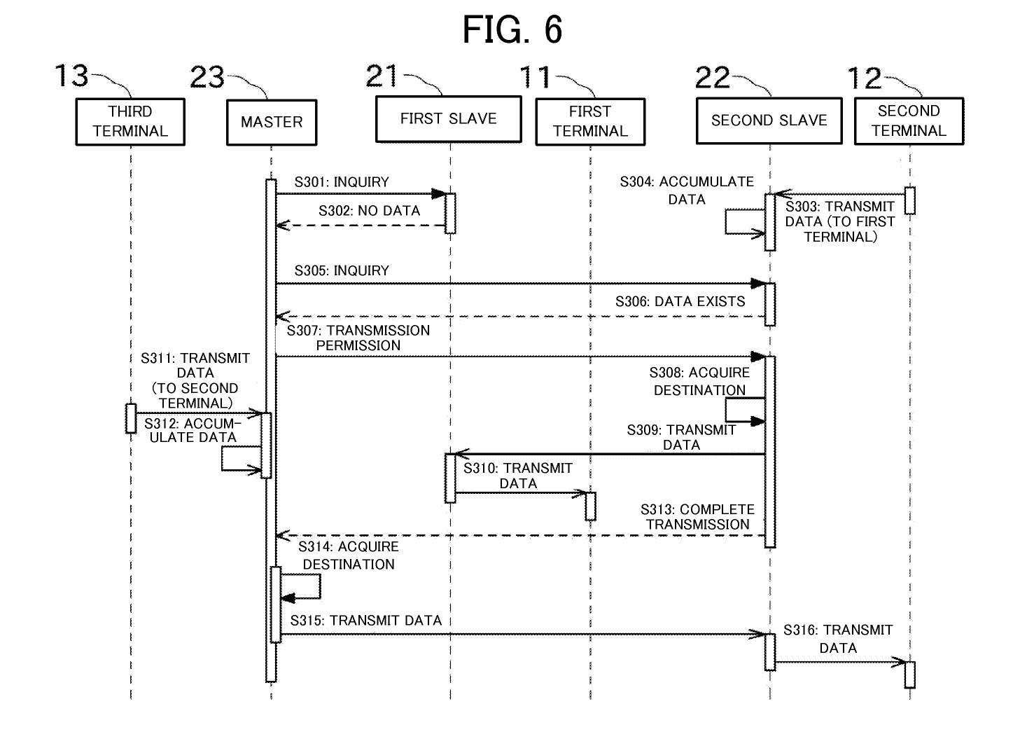

Next, operations of the relay communication system 1 of the present preferred embodiment will be specifically described by exemplifying a sequence diagram of FIG. 6.

Firstly, the inquiry signal that inquires whether or not there is transmission waiting data is preferably transmitted to the slaves by the polling processing unit 40 of the master (the third relay communication device) 23. As described above, the inquiry signal by the polling processing unit 40 is transmitted to the slave stored in the device information table in the order in which the slaves are stored in the device information table. In FIG. 3, for example, since the IP address of the first slave (the first relay communication device) 21 is stored in the first place of the device information table, the polling processing unit 40 firstly transmits the inquiry signal to the first slave (the first relay communication device) 21 (sequence number S301).

In an example of FIG. 6, a situation in which the first slave 21 does not have “transmission waiting data” is assumed. The first slave 21 returns “no transmission waiting data” in the case where there is no transmission waiting data (sequence number S302).

The polling processing unit 40 of the master transmits the inquiry signal to the next slave in the case of receiving the reply of “no transmission waiting data” from the first slave. Since the IP address of the second slave (the second relay communication device) 22 is registered next to the first slave in the device information table of FIG. 3, the inquiry signal is transmitted to the second slave 22 (sequence number S305).

In the example of FIG. 6, a situation in which the second slave 22 has “transmission waiting data” is assumed. That is, before the master 23 transmits the inquiry signal to the second slave 22, the second terminal 12 connected to the second slave 22 transmits data bound for the first terminal 11 (sequence number S303). The data transmitted by the second terminal 12 is accumulated in the communication buffer 33 of the second slave 22 (sequence number S304). Therefore, the second slave 22 having received the inquiry signal from the master 23 transmits the reply of “transmission waiting data exists” (sequence number S306).

The transmission permission granting unit 41 of the master 23 having received the reply of “transmission waiting data exists” transmits the transmission permission signal to the second slave 22 (sequence number S307). At the same time, the master 23 interrupts the inquiry into the next slave.

The destination acquiring unit 37 of the second slave that has received the transmission permission acquires the address of the relay communication device to which the transmission waiting data is to be transmitted (sequence number S308). In the example of FIG. 6, since the first terminal 11 is designated as a transmission destination of the transmission waiting data, the IP address of the first slave 21 connected to the first terminal 11 is acquired.

Next, the transmission data processing unit 38 of the second slave wirelessly transmits the transmission waiting data from the second communication unit 32 to the acquired IP address (sequence number 309). The transmitted data is received in the second communication unit 32 of the first slave 21.

The received data processing unit 39 of the first slave 21 transmits the data received in the second communication unit 32 from the first communication unit 31 (sequence number S310). The data is received by the first terminal 11 connected to the first communication unit 31 of the first slave 21. In this manner, the data bound for the first terminal 11 from the second terminal 12 can be wirelessly transmitted via the relay communication system 1.

The transmission data processing unit 38 of the second slave 22 that has completed the transmission of the transmission waiting data transmits a transmission completion report to the master 23 (sequence number S313).

In the case where the master 23 receives the transmission completion report, the polling restart processing unit 42 of the master 23 restarts the inquiry into the next slave. As described above, since the amount of data allowed to be transmitted by the second slave 22 at one time is limited to a predetermined amount of data or less, the transmission of the data by the second slave 22 is reliably completed within a predetermined time period. Therefore, the inquiry into the next slave can be reliably restarted within a predetermined time period.

However, as described above, in the case where the master 23 has transmission waiting data, the master 23 transmits its own transmission waiting data before performing the inquiry into the next slave.

In the example of FIG. 6, for example, assumed is a case where the third terminal 13 connected to the master 23 has transmitted data bound for the second terminal 12 (sequence number 5311) before receiving a transmission completion report from the second slave. In this case, the data from the third terminal 13 is accumulated in the communication buffer 33 of the master 23 (sequence number S312). In the case where there is the transmission waiting data in the master 23, the destination acquiring unit 37 of the master 23 acquires the IP address of the slave to which the data is to be transmitted. In the case of FIG. 6, the IP address of the second slave 22 connected to the second terminal 12, which is the destination of the transmission waiting data, is acquired (sequence number S314). The transmission data processing unit 38 transmits its own transmission waiting data to the acquired IP address (sequence number S315). The received data processing unit 39 of the second slave 22 that has received the data transmits the data to the second terminal 12 (sequence number S316). As described above, in the case where the amount of transmission waiting data to be transmitted by the master is large, data transmission of this time is completed after the predetermined amount of the data is transmitted even if transmission waiting data is remained. The master causes the polling processing unit 40 to restart the inquiry into the next slave in the case where transmission of its own transmission waiting data is completed.

As described above, the relay communication system 1 of the present preferred embodiment includes the plurality of the relay communication devices 21, 22, and 23. Each relay communication device preferably includes the operation mode setting unit 36, the first communication unit 31, the second communication unit 32, the communication buffer 33, the transmission data processing unit 38, the received data processing unit 39, the polling processing unit 40, the transmission permission granting unit 41, and the polling restart processing unit 42.

The operation mode setting unit 36 determines whether to function as the master or as the slave. The first communication unit 31 communicates with a terminal device connected thereto. The second communication unit 32 communicates with other relay communication devices. The communication buffer 33 temporarily accumulates data received via the first communication unit 31.

The transmission data processing unit 38, in the case of functioning as the slave, starts transmitting transmission waiting data accumulated in the communication buffer 33 from the second communication unit 32 in accordance with the transmission permission from the master, and limits the amount of the data allowed to be transmitted with one transmission permission to a predetermined amount of data or less. The received data processing unit 39, in the case where the data received via the second communication unit 32 is bound for a terminal device connected thereto, transmits the data from the first communication unit 31.

The polling processing unit 40, in the case of functioning as the master, transmits an inquiry signal that inquires whether or not there is data accumulated in the communication buffer 33 to the slave in a predetermined order. The transmission permission granting unit 41, in the case of functioning as the master and receiving a reply of “transmission waiting data exists” from the slave to which the inquiry signal has been transmitted, interrupts the inquiry by the polling processing unit 40 and transmits transmission permission to the slave that has returned the reply. The polling restart processing unit 42, in the case of functioning as the master, causes the polling processing unit 40 to restart the inquiry into the next slave in the case where transmission of the data is completed.

By the above-described configuration, since data is transmitted from the slave only in the case where the master grants the permission, transmission collision can be prevented from occurring in advance. Accordingly, since communication delay caused by transmission collision can be avoided, the responsiveness of the entire relay communication system 1 can be ensured. Additionally, since the inquiry from the master to the slave is performed in a predetermined order (not in a random order), the transmission permission is reliably granted to the slave having data to be transmitted within a predetermined time period. Therefore, each slave can reliably transmit the data within the predetermined time period in the case of having the data to be transmitted. Since the amount of the data to be transmitted from the slave at one time is limited to the predetermined amount of the data or less, the inquiry by the master can be prevented from being interrupted for a long period of time. The responsiveness of the relay communication system 1 thus can be improved.

As in the present preferred embodiment, since the relay communication device is configured to be capable of functioning as the master (the communication control device), cost can be reduced by using common hardware and a flexible configuration of the relay communication system 1 becomes available.

In the relay communication system 1 according to the above-described preferred embodiment, each relay communication device preferably includes the destination acquiring unit 37 arranged to specify the relay communication device, which is the destination of data accumulated in the communication buffer 33. The second communication unit 32 of each relay communication device is capable of communicating with other relay communication device. The transmission data processing unit 38 of each relay communication device transmits the data to the relay communication device specified by the destination acquiring unit 37 based on the transmission permission from the master.

In this configuration, each relay communication device preferably transmits data to another relay communication device only in the case where the communication transmission is granted. Transmission collision thus can be reliably prevented.

Next, setting processing in the case of initially setting the relay communication system 1 will be described.

An administrator of the relay communication system 1 wire-connects each terminal device 11, 12, and 13 to the first communication units 31 of the relay communication devices respectively for appropriate arrangement of them. In this state, nothing is stored in the device information storage unit 34 of each relay communication device 21, 22, and 23 (the device information tables are in a blank state).

Next, the administrator of the relay communication system 1 selects as the master any one of the plurality of relay communication devices 21, 22, and 23 that constitute the relay communication system 1, and sets the operation mode setting unit 36 of each relay communication device. As illustrated in FIG. 1, the third relay communication device 23 is set as the master. Subsequently, the administrator sets the device information table in the device information storage unit 34 of the master 23 by carrying out adequate operations.

The control unit 35 of the master 23 acquires the IP addresses of other relay communication devices (the first slave 21 and the second slave 22 in the case of FIG. 1) by referring to the set device information table, and transmits the contents of the device information table stored in its own device information storage unit 34 from the second communication unit 32 to the IP addresses. Therefore, the control unit 35 of the master 23 can also preferably function as a device information distributing unit 43.

Upon receiving the device information table from the master 23, each slave 21 and 22 stores the received device information table in its own device information storage unit 34. As described above, the device information table can be stored in the device information storage units 34 of each relay communication device 21, 22, and 23 that constitutes the relay communication system 1.

Next, the polling processing unit 40 of the master 23 refers to the device information table and transmits the inquiry signal to each slave in order. Since each relay communication device 21, 22, and 23 does not have transmission waiting data at this stage where the relay communication system 1 has been installed, the first slave 21 and the second slave 22 return a reply of “no transmission waiting data”. By receiving the reply of “no transmission waiting data”, the master 23 can confirm that communication with each slave 21 and 22 can be performed normally.

Since each relay communication device 21, 22, and 23 does not have transmission waiting data at the stage where the relay communication system 1 has been installed, the second communication unit 32 of each relay communication device 21, 22, and 23 does not transmit data. Therefore, since the inquiry by the polling processing unit 40 of the master 23 is not interrupted, time required for making one round of the device information table (time required to take for completing the inquiries into all the slaves) becomes the shortest. The time required to make one round of the device information table thus becomes an index of the responsiveness of the relay communication system 1.

The master 23 is configured to measure the time required to make one round of the device information table (the time required to take for completing the inquiries into all the slaves) when the relay communication system 1 is installed for the first time. In the case where the time measurement is completed, the master 23 outputs the time required to make one round of the device information table using an adequate measure.

The administrator of the relay communication system 1 can adjust the relay communication system 1 by checking the output of the master 23. In the case where the responsiveness is low (e.g., where making one round of the device information table takes an excessive amount of time), for example, there may be too many relay communication devices in the relay communication system 1. Accordingly, it is determined that the relay communication devices should be reduced. On the contrary, in the case where adequate responsiveness is achieved, it is determined that there is no problem in further adding a relay communication device.

Next, in the relay communication system 1 of the above-described preferred embodiment, a case where the terminal device and the relay communication device are added or removed will be described.

The administrator of the relay communication system 1 updates the contents of the device information table of the master 23 by carrying out an adequate operation when adding or removing the relay communication device and terminal device. For example, in the case where a fourth relay communication device connected to a fourth terminal device is newly added to the relay communication system 1 as illustrated in FIG. 1, the device information storage unit 34 of the master 23 is caused to associate the terminal ID of the fourth terminal with the IP address of the fourth relay communication device for storing. On the other hand, in the case of removing the existing relay communication device and terminal device from the relay communication system 1, the relevant information is deleted from the device information table of the master 23.

In the case where the device information table of the master 23 is updated, the device information distributing unit 43 of the master 23 distributes the updated device information table to each slave by choosing a timing in which any slave is not performing the communication by the second communication unit 32 (specifically, at a timing just before the master makes the inquiry into the next slave). Each slave having received the updated device information table updates the storage contents of its own device information storage unit 34 with the received contents.

According to the above-described configuration, since the storage contents of the device information storage units 34 of each relay communication device can be easily updated, the configuration of the relay communication system 1 can be easily changed. Therefore, the relay communication device and the terminal device can be easily added or removed.

Next, a second preferred embodiment of the present invention will be described. In the following description, the same or similar configurations as in the above-described first preferred embodiment receive the same reference numerals of the first preferred embodiment in the drawings and element names to omit description thereof in some cases.

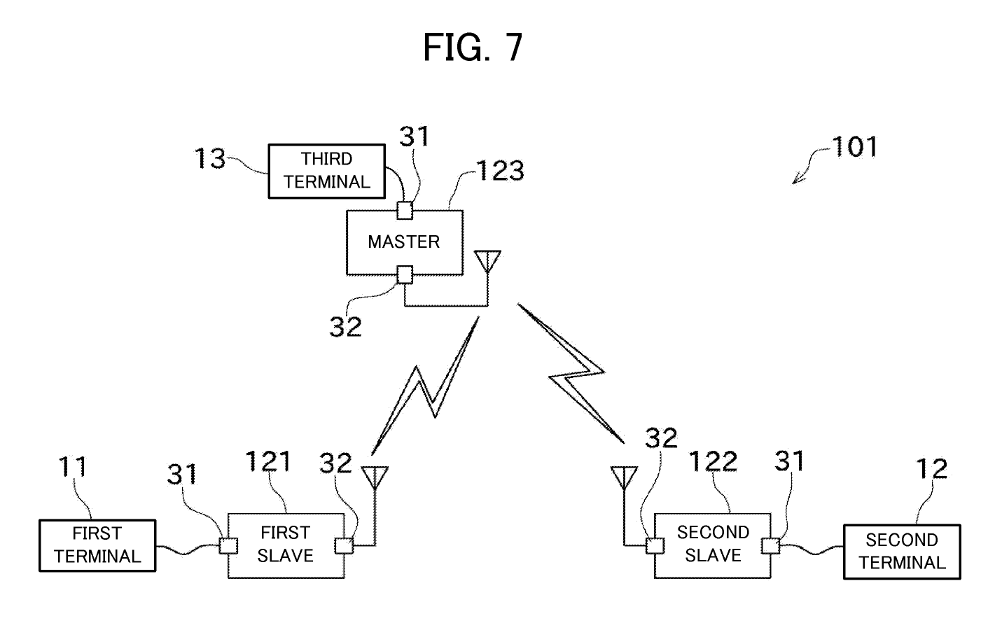

A configuration of a relay communication system 101 according to the second preferred embodiment is illustrated in FIG. 7. The relay communication system 101 of the present preferred embodiment, as described with respect to the first preferred embodiment, also preferably includes the plurality of terminal devices 11, 12, and 13. The first terminal 11, the second terminal 12, and the third terminal 13 are respectively connected to a first relay communication device 121, a second relay communication device 122, and a third relay communication device 123. In the present preferred embodiment, the third relay communication device 123 is preferably the master (the communication control device), and the first relay communication device 121 and the second relay communication device 122 are preferably the slaves.

In the relay communication system 1 of the first preferred embodiment, the slave to which the master has granted the transmission permission directly transmits data to the destination relay communication device. On the contrary, in the relay communication system 101 of the second preferred embodiment, while the slaves are not configured to perform direct transmission and reception of data with each other, the master is configured to relay all data.

That is, in the second preferred embodiment, each slave (the first slave 121 and the second slave 122) is preferably configured to communicate only with a master 123 via the second communication unit 32. Therefore, the slaves do not communicate with each other via the second communication units 32.

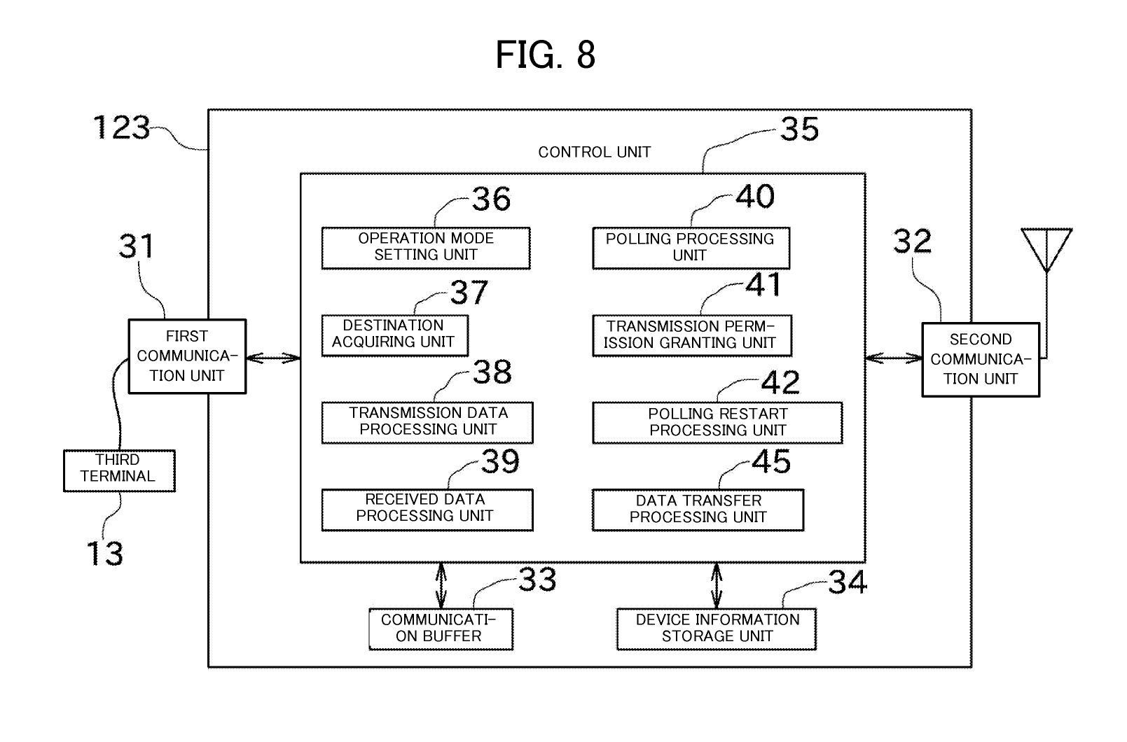

Next, a configuration of the relay communication device of the second preferred embodiment will be described with reference to FIG. 8. Likewise in the second preferred embodiment, since the relay communication devices 121, 121, and 123 preferably use common hardware, the third relay communication device 123 is illustrated as a representative in FIG. 8.

The relay communication device of the second preferred embodiment, as found in the first preferred embodiment, preferably includes the first communication unit 31, the second communication unit 32, the communication buffer 33, the device information storage unit 34, and the control unit 35.

In the present preferred embodiment, the storage contents of the device information storage units 34 of each relay communication device vary according to whether the operation mode of the relay communication device is that of the master or the slave.

As described above, each slave 121 and 122 communicates only with the master 123. Therefore, in the case where the operation mode of the relay communication device is that of the slave, information required for communication by the second communication unit 32 is only the identifier (the IP address) of the master 123, and IP addresses of the relay communication devices other than the master are not required. In the present preferred embodiment, only the identifier (e.g., the IP address) of the master 123 is thus stored in the device information storage units 34 of the slaves 121 and 122.

On the other hand, the device information storage unit 34 of the master 123, as described with respect to the first preferred embodiment, preferably stores device information (device information table) that associates the identifier (IP address) of each relay communication device 121, 122, and 123 with the identifier (the terminal ID) of the terminal device connected to the respective relay communication devices (same contents as found in FIG. 3).

The control unit 35 of the second preferred embodiment is, as described with respect to the first preferred embodiment, preferably configured to be capable of functioning as the operation mode setting unit 36, the destination acquiring unit 37, the transmission data processing unit 38, the received data processing unit 39, the polling processing unit 40, the transmission permission granting unit 41, the polling restart processing unit 42, or the like.

The control unit 35 of the second preferred embodiment preferably further has a function as a data transfer processing unit 45.

In the case where the operation mode of the relay communication device is that of the slave (in case of not functioning as the communication control device), the transmission data processing unit 38 of the second preferred embodiment transmits transmission waiting data from the second communication unit 32 to the master when receiving transmission permission signal from the master. Since the IP address of the master is stored in the device information storage unit 34, the transmission is performed merely to this IP address. The data as transmitted in the above-described manner is received in the second communication unit 32 of the master.

In the case where the operation mode of the relay communication device is that of the master (in the case of functioning as the communication control device), the data transfer processing unit 45, when data is transmitted from the slave to which the transmission permission has been granted, causes the destination acquiring unit 37 to acquire the identifier (the IP address) of the relay communication device to which the data is to be transferred.

The destination acquiring unit 37 is configured to acquire the IP address of the relay communication device to which the data is to be transmitted.

The specifics will be described below. As described with respect to the first preferred embodiment, each terminal device attaches, information that designates the terminal ID of a destination terminal device, to data when transmitting the data. In FIG. 7, for example, in the case where the first terminal 11 transmits data to the second terminal 12, the first terminal 11 transmits the data designating the terminal ID of the second terminal 12 as the destination. The data is accumulated in the communication buffer 33 of the first slave 121 to be transmission waiting data.

In the case where transmission permission is granted from the master 123 to the first slave 121, the first slave 121 transmits the data designating the second terminal 12 as the destination to the master 123. The destination acquiring unit 37 of the master 123 analyzes the data to acquire the terminal ID of the destination terminal device (the second terminal 12 in this example). The destination acquiring unit 37 of the master 123 then acquires the IP address of the relay communication device connected to the destination terminal device (the second slave 122 in this example) by referring to the device information table. In this manner, the destination acquiring unit 37 of the master can acquire the IP address of the relay communication device to which the data received from the slave is to be transferred.

The data transfer processing unit 45 of the master 123 transmits the data from the second communication unit 32 to the IP address acquired by the destination acquiring unit 37. By the above-described processing, the master 123 can transfer the data transmitted from one slave to other slave (the second slave 122 in the above-described case) connected to the terminal device, which is designated as the destination of the data.

As described above, in the relay communication system 101 of the second preferred embodiment, data transmitted from the second communication unit 32 of each slave necessarily goes through the master 123. By exchanging data between the slaves 121 and 122 via the master 123, the master 123 can adjust data communication between the slaves 121 and 122.

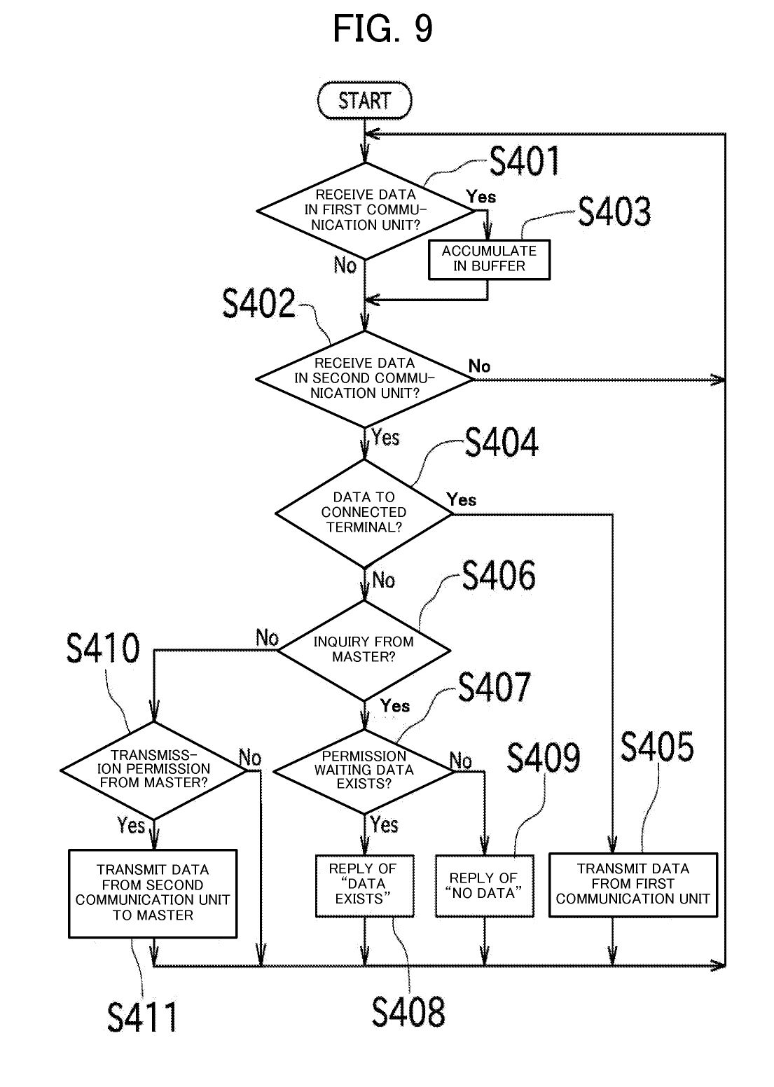

Next, operations of the relay communication device functioning as the slave will be described with reference to a flowchart of FIG. 9.

Since processing from S401 to S409 is the same as processing from S101 to S109 in FIG. 4, specific description thereof will be omitted.

In the case where transmission permission signal from the master 123 is received in the second communication unit 32 (step S410), a respective one of the transmission data processing units 38 of the slaves 121 and 122 of the second preferred embodiment transmits transmission waiting data to the master 123 (step S411).

Likewise in the second preferred embodiment, the amount of data allowed to be transmitted at one time from the second communication unit 32 of the one of the slaves 121 and 122 is limited to a predetermined amount or less. That is, in the case where the predetermined amount of data is transmitted from the second communication unit 32 in step S401, even if transmission waiting data is remained, the data transmission of this time is completed to proceed to step S411. The remaining data is transmitted from next time onward.

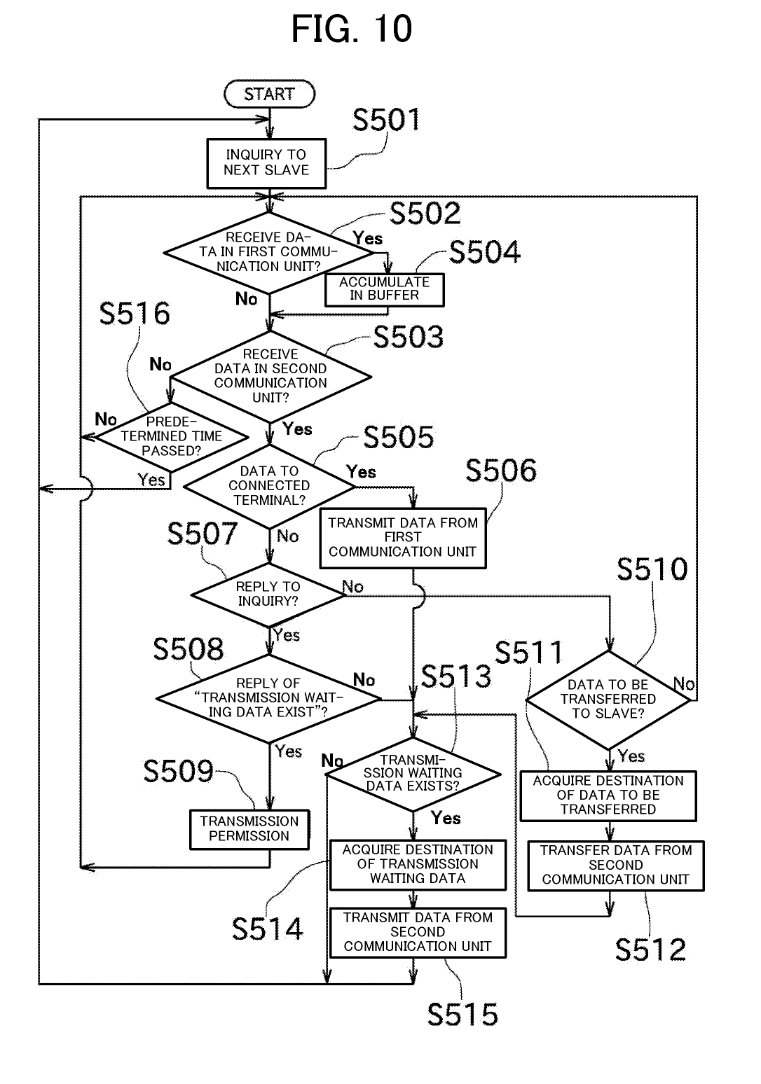

Next, operations of the relay communication device functioning as the master will be described with reference to a flowchart of FIG. 10.

Since processing from S501 to S506 is the same as processing from S201 to S206 in FIG. 5, description thereof will be omitted.

In the case where a reply from the one of the slaves 121 and 122 in response to the inquiry signal is received in the second communication unit 32 of the master 123 (step S507), the master 123 branches the processing in accordance with the contents of the reply. That is, in the case of receiving the reply of “transmission waiting data exists” from the one of the slaves 121 and 122 (determination in step S508), the transmission permission granting unit 41 of the master 123 transmits transmission permission signal from the second communication unit 32 to the one of the slaves 121 and 122 (step S509). At this time, the transmission permission granting unit 41 interrupts the inquiry by the polling processing unit 40 (step S501). This is realized by returning to step S502 after step S509 in the flowchart of FIG. 10.

In the case where the data from the one of the slaves 121 and 122 to which the transmission permission has been granted is received in the second communication unit 32 (step S510), the data transfer processing unit 45 performs transfer processing of the data. That is, the data transfer processing unit 45 causes the destination acquiring unit 37 to acquire the IP address of the one of the slaves 121 and 122 to which the received data is to be transferred (step S511). The data transfer processing unit 45 transmits the data to the acquired IP address (step S512).

In the case where the data transfer by the data transfer processing unit 45 is completed, the polling restart processing unit 42 causes the polling processing unit 40 to restart the inquiry processing (that is, returning to step S501).

As described above, since the amount of data transmitted by the second slave 22 at one time is limited to a predetermined amount of data or less, the capacity of data required to be transferred by the master 23 at one time is limited. Therefore, the data transfer by the master 23 is reliably completed within a predetermined time period. The inquiry into the next one of the slaves 21 and 22 thus can be restarted reliably within the predetermined time period.

Likewise in the second preferred embodiment, the master 123 is configured to interrupt the inquiry into the next one of the slaves 121 and 122 and to transmit its own transmission waiting data in the case where the master 123 has the transmission waiting data. That is, in the case where there is transmission waiting data (determination in S513), the destination acquiring unit 37 of the master 123 acquires the IP address of the relay communication device to which the transmission waiting data is to be transmitted (step S514), and the transmission data processing unit 38 of the master 123 transmits the transmission waiting data to the acquired IP address (step S515). The master 123 returns to step S501 and restarts the inquiry into the next one of the slaves 121 and 122 in the case where the transmission of the data by the transmission data processing unit 38 is completed.

Likewise in the second preferred embodiment, in the case where the master 123 transmits transmission waiting data, the amount of data allowed to be transmitted from the second communication unit 32 at one time is limited to a predetermined amount of data or less. In this manner, since the inquiry into the one of the slaves 121 and 122 by the master can be prevented from being interrupted for a long period of time, the responsiveness of the relay communication system can be improved.

According to the above-described configuration, the master 123 can transmit its own transmission waiting data from the second communication unit 32 in between the inquiries into the slaves 121 and 122 or data transfers.

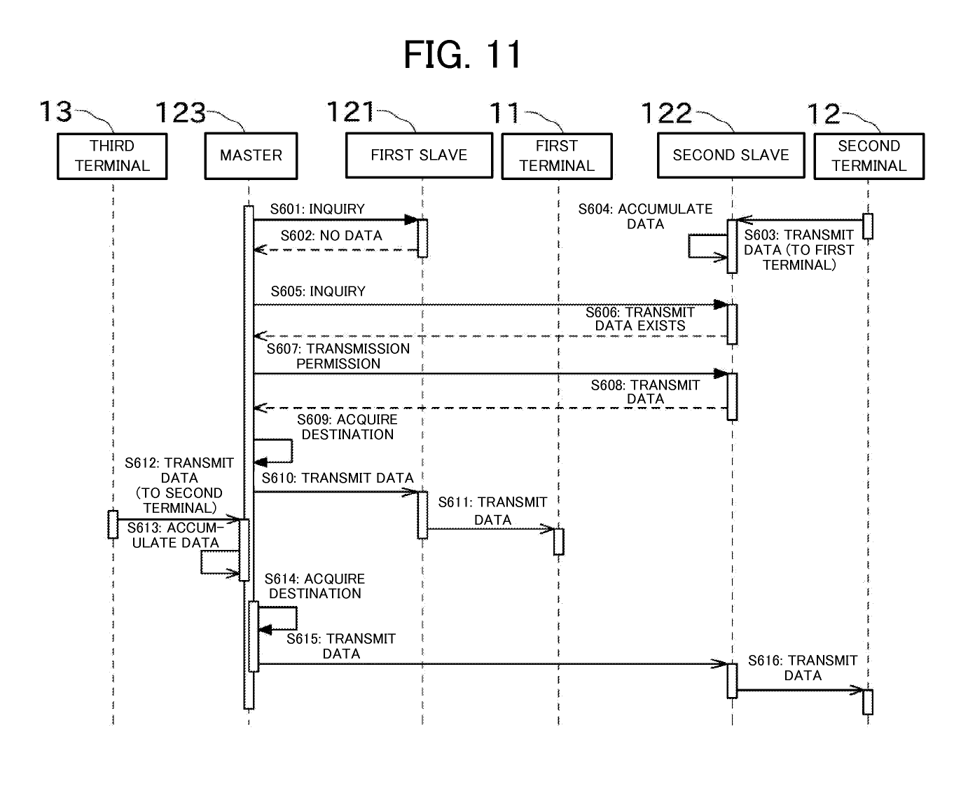

Next, operations of the relay communication system 1 of the present preferred embodiment will be specifically described by exemplifying a sequence diagram of FIG. 11.

Since processing of sequence numbers from S601 to S607 is the same as processing of sequence numbers from S301 to S307 in FIG. 6, specific description thereof will be omitted.

The transmission data processing unit 38 of the second slave 122 having received the transmission permission transmits transmission waiting data to the master 123 (sequence number S608). As described above, in the case where the amount of the transmission waiting data to be transmitted by the second slave 122 is large, the data transmission of this time is completed after the predetermined amount of the data is transmitted even if transmission waiting data is remained.

Since the data received by the master 123 at this time is destined for the first terminal 11, the data is required to be transferred to the first slave 121 connected to the first terminal 11. The data transfer processing unit 45 of the master 123 causes the destination acquiring unit 37 to acquire the IP address of the relay communication device (the first slave 121 in this case) to which the data is to be transferred (sequence number S609).

The data transfer processing unit 45 transfers the data from the second communication unit 32 to the acquired IP address (sequence number S610). The transmitted data is received by the second communication unit 32 of the first slave 121. The received data processing unit 39 of the first slave 121 transmits the received data from the first communication unit 31 (sequence number S611). The data is received by the first terminal 11 connected to the first communication unit 31 of the first slave 121. As described above, the data bound for the first terminal 11 from the second terminal 12 can be wirelessly transmitted through the relay communication system 101 of the second preferred embodiment.

When the data transfer processing unit 45 completes the transmission of the data, the polling restart processing unit 42 of the master 123 restarts the inquiry into the next slave. As described above, since the amount of data to be transmitted by the slave at one time is limited to the predetermined amount of data or less, the data transfer by the master is reliably completed within the predetermined time period. Therefore, the inquiry into the next slave can be restarted in a short time.

As described above, in the case where the master 123 has transmission waiting data, the master 123 transmits its own transmission waiting data before making the inquiry into the next slave (sequence numbers from S612 to S616). The master causes the polling processing unit 40 to restart the inquiry into the next slave in the case where transmission of its own transmission waiting data is completed.

As described above, in the relay communication system 101 of the second preferred embodiment, the transmission data processing unit 38 of each relay communication device is preferably configured to transmit data to the master 123 in accordance with transmission permission from the master 123. The relay communication device is, in the case of functioning as the master 123, provided with the destination acquiring unit 37 arranged to specify a relay communication device, which is the destination of the data to be transmitted from the second communication unit 32, and the data transfer processing unit 45 arranged to cause the destination acquiring unit 37 to specify the relay communication device to which the data, received from the relay communication device to which the transmission permission has been granted, is to be transferred, and to transmit the data to the specified relay communication device.

In this configuration, since the master 123 transfers data transmitted by each relay communication device in an integrated manner, transmission collision can be reliably prevented.

Although preferred embodiments of the present invention are described as above, the above-described configurations, for example, may be changed as follows.

Although in the above-described preferred embodiments, the relay communication device (the master) functioning as the communication control device and other relay communication device (the slave) preferably have a common hardware configuration, the communication control device and other relay communication device may have different hardware configurations. Additionally, the communication control device itself may not be connected to a terminal device (that is, the communication control device may not have the function as the relay communication device).

Although each function of the relay communication device preferably is realized by collaboration between the hardware and the software, some or all of the functions may also be realized with dedicated hardware alone.

In the above-described preferred embodiments, preferably the first communication unit performs wired communication and the second communication unit performs wireless communication, but the present invention is not necessarily limited thereto. For example, the second communication unit may be configured to perform wired communication. The configuration of the preferred embodiments of the present invention can also be utilized to avoid transmission collision that occurs in wire communication.

In the above-described preferred embodiments, the polling processing unit 40 of the master makes the inquiry into the slave in accordance with the order of the device information table stored in the device information storage unit 34. However, without limiting thereto, information that determines order of the inquiry into the slave may be provided separately from the device information table. In short, what matters is that the inquiry into each slave is reliably performed within a predetermined order.

Since the inquiry is not required to be performed to all the slaves equally, the inquiry may be performed to a specific slave more frequently than to other slave. The frequency of inquiring whether or not there is transmission waiting data may vary by slave, for example, such that per two inquires into the first slave 21 the second slave 22 is inquired only one time. With this manner, such flexible handling as preferentially grants opportunities to transmit data to a specific relay communication device becomes possible. Even in this case, as long as inquiry into a slave is performed in a predetermined order, the inquiry can be reliably performed to each slave within a predetermined time period.

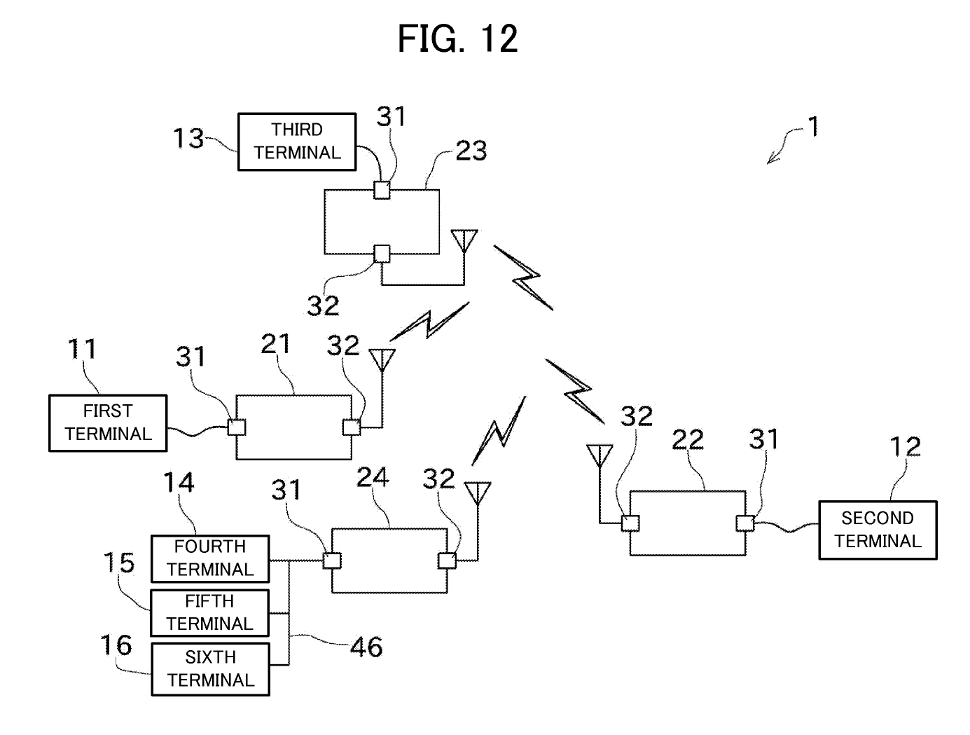

In the above-described preferred embodiments, one terminal device is respectively connected to the first communication unit 31 of each relay communication device. However, in serial communication such as, for example, CAN, a plurality of terminals can be connected to one bus. A plurality of terminal devices 14, 15, 16 . . . thus can be connected to the first communication unit 31 via a bus 46 as exemplified by the relay communication device 24 illustrated in FIG. 12.

In this case, the terminal device 14 in FIG. 12, for example, can transmit data to a terminal device as a destination, which is connected to other relay communication device (a terminal device 11, 12, or 13 in the case of FIG. 12), and can also transmit data to a terminal device as a destination, which is connected to the same relay communication device 24 (a terminal device 15 or 16 in the case of FIG. 12). Since the relay communication device 24 manages terminal IDs of terminal devices connected thereto, the relay communication device 24 can determine whether communication between the terminals connected thereto or communication bound for a terminal device connected to other relay communication device in accordance with a destination of data received in the first communication unit 31.

In the case where a destination of data received in the first communication unit 31 is a communication terminal connected to a relay communication device other than itself, the relay communication device 24, as described already, accumulates the data in the communication buffer 33. On the other hand, in the case where a destination of data received in the first communication unit 31 is one of the terminal devices connected to itself, the relay communication device 24 is not required to wirelessly transmit the data from the second communication unit 32. In this case, the terminal device, which is the destination of the data, can receive the data via the bus 46 connected to the first communication unit 31 of the relay communication device 24. The relay communication device 24 is thus configured to accumulate data in the communication buffer 33 only in the case where a destination of the data received in the first communication unit 31 is one of the terminal devices connected to other relay communication device. Accordingly, since data not required to be wirelessly transmitted is not accumulated in the communication buffer 33, the data not required to be wirelessly transmitted is prevented from being transmitted from the second communication unit 32, and volume of the communication buffer 33 can be saved.

As described above, even when a plurality of terminal devices is connected to the relay communication device, communication between the terminal devices can be adequately performed.

In FIG. 12 of the above-described variant preferred embodiment, although a plurality of terminal devices preferably is connected to one first communication unit 31, the relay communication device may include a plurality of first communication units to which terminal devices are connected.

In the above-described preferred embodiment, the master 23 transmits its own transmission waiting data before making the inquiry into the next slave. In this configuration, the master 23 has more opportunities to be able to transmit transmission waiting data in comparison with the first slave 21 and the second slave 22 (since an opportunity to transmit data is granted every time the master 23 makes the inquiry into each slave). Therefore, a terminal device having large amount of data to be transmitted is preferably connected to the master 23. Without limiting thereto, for example, it may be possible to make such configuration as transmits transmission waiting data of the master only when making one round of the device information table (when the inquiries into all the slaves are completed). According to this configuration, the master and the other slaves have equal opportunities to transmit transmission waiting data.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A relay communication system comprising:
a plurality of relay communication devices; and
a communication control device including:
a first communication unit arranged to communicate with a terminal device connected thereto;
a second communication unit arranged to communicate with at least the communication control device;
a communication buffer arranged to temporarily accumulate data received via the first communication unit;
a transmission data processing unit arranged to start transmitting the data accumulated in the communication buffer from the second communication unit in accordance with transmission permission from the communication control device and to limit an amount of the data allowed to be transmitted with one transmission permission to a predetermined amount of the data or less; and
a received data processing unit arranged to transmit the data from the first communication unit in a case where a destination of data received via the second communication unit is the terminal device connected thereto; wherein
the communication control device includes:
a communication unit arranged to communicate with one of the plurality of relay communication devices;
a polling processing unit arranged to transmit to the one of the plurality of relay communication devices an inquiry signal that inquires whether or not data has accumulated in the communication buffer in accordance with a predetermined order;
a transmission permission granting unit arranged to interrupt the inquiry by the polling processing unit in a case of receiving a reply indicating that data has accumulated in the one of the plurality of relay communication devices to which the inquiry signal has been transmitted, and to transmit the transmission permission to one of the plurality of relay communication devices that has returned the reply; and
a polling restart processing unit arranged to cause the polling processing unit to restart the inquiry into a next relay communication device after transmission of the data is completed.

2. The relay communication system according to claim 1, wherein the one of the plurality of relay communication devices accumulates the data in the communication buffer only in a case where a destination of the data received via the first communication unit is a terminal device connected to another of the plurality of relay communication devices.

3. The relay communication system according to claim 1, wherein frequency of transmission of the inquiry signal by the polling processing unit varies according to each of the plurality of relay communication devices.

4. The relay communication system according to claim 1, wherein each of the plurality of relay communication devices includes a destination acquiring unit arranged to specify the relay communication device that is a destination of the data accumulated in the communication buffer, and the second communication unit of each of the plurality of relay communication devices can communicate with others of the plurality of relay communication devices, and the transmission data processing unit of each of the plurality of relay communication devices transmits the data to the relay communication device specified by the destination acquiring unit in accordance with the transmission permission.

5. The relay communication system according to claim 1, wherein the transmission data processing unit of each of the plurality of relay communication devices is configured to transmit the data to the communication control device in accordance with the transmission permission; and
the communication control device includes:
a destination acquiring unit arranged to specify the relay communication device that is a destination of data to be transmitted from the communication unit; and
a data transfer processing unit arranged to cause the destination acquiring unit to specify the relay communication device to which the data, received from the relay communication device to which the transmission permission have been granted, is to be transferred, and to transmit the data to the specified relay communication device.

6. A relay communication device comprising:
an operation mode setting unit arranged to set whether to function as a communication control device or a slave device;
a first communication unit arranged to communicate with a terminal device connected thereto;
a second communication unit arranged to communicate with a relay communication device;
a communication buffer arranged to temporarily accumulate data received via the first communication unit;
a transmission data processing unit arranged to start transmitting the data accumulated in the communication buffer from the second communication unit in accordance with transmission permission from a relay communication device functioning as the communication control device and to limit an amount of the data allowed to be transmitted with one transmission permission to a predetermined amount of data or less in a case of functioning as the slave device;
a received data processing unit arranged to transmit the data from the first communication unit in the case where a destination of data received via the second communication unit is the terminal device connected thereto;
a polling processing unit arranged to transmit to the relay communication device functioning as the slave device an inquiry signal that inquires whether or not data has accumulated in the communication buffer in a predetermined order in a case of functioning as the communication control device;
a transmission permission granting unit arranged to interrupt the inquiry by the polling processing unit and to transmit the transmission permission to one of the plurality of relay communication devices that has returned the reply in the case of functioning as the communication control device and to receive from the relay communication device the reply indicating that data has accumulated in the one of the plurality of relay communication devices to which the inquiry signal has been transmitted; and
a polling restart processing unit arranged to cause the polling processing unit to restart the inquiry into the next relay communication device after transmission of the data is completed in the case of functioning as the communication control device.
